(19) United States
(12) Patent Application Publication
(10) Pub. No.: US 2026/0307738 A1
(43) Pub. Date: Oct. 8, 2026

(54) REAR VEHICLE BODY CONNECTION STRUCTURE OF ROOF STRUCTURE

(71) Applicants: Kia Corporation, Seoul (KR); Hyundai Motor Company, Seoul (KR)

(72) Inventors: Hae Hoon Lee, Hwaseong-si (KR); Byeongkyu Kwon, Hwaseong-si (KR); Dong Wook Kim, Hwaseong-si (KR); Hoyeon Kim, Hwaseong-si (KR)

(21) Appl. No.: 19/401,235

(22) Filed: Nov. 25, 2025

(30) Foreign Application Priority Data
Apr. 2, 2025 (KR) 10-2025-0042548
May 20, 2025 (KR) 10-2025-0065174

(51) Int. Cl. B62D 27/02; B62D 25/02; B62D 25/04; B62D 25/06; B62D 25/08

(52) U.S. Cl. CPC B62D 27/023; B62D 25/02; B62D 25/04; B62D 25/06; B62D 25/087

(57) ABSTRACT

A rear vehicle body connection structure of a roof structure that connects a high-roof module including a high-roof panel arranged at a height difference from a rear vehicle body to the rear vehicle body, wherein the rear vehicle body includes a rear pillar lower unit as a common element, wherein the rear vehicle body connection structure includes a rear pillar upper unit connected to the rear pillar lower unit, and a joint unit connecting an upper part of the rear pillar upper unit and a rear part of the high-roof module.

### CROSS-REFERENCE TO RELATED APPLICATION

This application claims priority to and the benefit of Korean Patent Application No. 10-2025-0042548 filed with the Korean Intellectual Property Office on Apr. 2, 2025, and Korean Patent Application No. 10-2025-0065174 filed with the Korean Intellectual Property Office on May 20, 2025, the entire contents of which are incorporated herein by reference.

### TECHNICAL FIELD

The present disclosure relates to a rear vehicle body connection structure of a roof structure.

### BACKGROUND

Recently, the vehicle industry has been introducing a new concept of future mobility vision for realizing a dynamic, human-centered future city. One of these future mobility solutions is a purpose-based vehicle (Purpose Built Vehicle; PBV).

PBV is an example of an electric vehicle (EV)-based environment-friendly mobility vehicle. PBVs can provide users with a variety of customized services while traveling from their starting point to their destination using autonomous driving technology.

PBV can be configured in various shapes and sizes depending on the user's use case. For example, PBV can be used as a hailing or delivery type vehicle. Furthermore, the PBV can be manufactured as a high-roof type vehicle to provide users with a wider vehicle interior space.

For example, a PBV of this type with a high roof can be manufactured by a modification method (e.g., external production method) in which the roof panel is post-processed on a basic vehicle body that is not of the high roof type and the high roof part is assembled on the post-processed part.

In another example, a high roof type PBV can be manufactured by manufacturing a dedicated body for the high roof type from the initial design stage (e.g., inline method).

However, in the former case, although the basic body can be shared, it is not possible to secure a wide interior space compared to the increased overall height due to the high roof structure, and it is not suitable for inline mass production.

Additionally, in the latter case, although a wide vehicle interior space and inline mass production can be secured, the basic vehicle body cannot be shared, which may lead to an increase in vehicle development period and investment costs.

The information contained in this background section is intended to enhance understanding of the background of the present disclosure and may include matters that are not conventional art already publicly known, available, or in use.

### SUMMARY

The disclosed example embodiments relate to a vehicle body, and more particularly, the present disclosure relates to a rear vehicle body connection structure of a roof structure capable of rigidly joining the roof structure and the rear vehicle body.

Embodiments of the present disclosure can provide a rear vehicle body connection structure of a roof structure suitable for inline mass production securing a high vehicle body height and a wide vehicle interior space by a high roof structure.

Some embodiments may provide a rear vehicle body connection structure of a roof structure that can be commonized to a variety of vehicle types to which the high roof structure can be applied.

For a rear vehicle body connection structure of a roof structure that connects a high roof module including a high roof panel arranged at a height difference from a rear vehicle body to the rear vehicle body, the rear vehicle body connection structure according to some embodiments may include a rear pillar lower unit as a common element provided in the rear vehicle body, a rear pillar upper unit connected to the rear pillar lower unit, and a joint unit connecting the upper part of the rear pillar upper unit and the rear part of the high roof module.

The rear pillar upper unit may be equipped as a variable element of the rear vehicle body.

The rear pillar upper unit may include an inner upper member connected to an inner lower member of the rear pillar lower unit, and an outer upper member connected to an outer lower member of the rear pillar lower unit and the inner upper member.

The joint unit may include a rear door hinge upper reinforcement member connected to the inner upper member and the outer upper member, and an upper bulk head connected to the inner upper member and the outer upper member, and connected to the upper part of the rear door hinge upper reinforcement member.

The upper bulk head may be provided as an inner joint part, and the rear door hinge upper reinforcement member may be provided as an outer joint part.

The upper bulk head may include a first flange portion connected to the inner upper member, and a second flange portion connected to the outer upper member and the rear door hinge upper reinforcement member.

The rear door hinge upper reinforcement member may include a side flange portion connected to the inner upper member, and an upper flange portion connected to the upper bulk head.

The upper bulk head may be connected to an inner extension member connected to the module side portions on both sides and both ends of the rear roof rail at the rear of the high roof module.

The upper bulk head may include a forming part connected to a support bracket provided on the inner extension member.

The support bracket provided on the inner extension member, the upper bulk head, and the rear door hinge upper reinforcement member may be connected along the vertical direction.

The joint unit may further include at least one upper joint part connected to the inner extension members connected to the module side portions on both sides and the ends of the rear roof rail at the rear portion of the high roof module.

The at least one upper joint part may include an outer extension front member connected to the inner extension member, the upper bulk head and the rear door hinge upper reinforcement member, and an outer extension rear member connected to the outer extension front member and connected to the inner extension member, the upper bulk head, and the rear door hinge upper reinforcement member.

The outer extension front member, the outer extension rear member, the upper bulk head, and the rear door hinge upper reinforcement member may be connected along the vertical direction through the outer upper member.

A first assembly process may be performed by connecting the upper bulk head to the inner upper member and connecting the inner upper member to the inner lower member.

A secondary assembly process may be performed to connect the rear door hinge upper reinforcement member to the inner upper member and the upper bulk head, and to connect the rear door hinge upper reinforcement member to the outer lower member and the outer upper member.

A third assembly process may be performed to connect the inner extension member with the upper bulk head.

After the third assembly process, a fourth assembly process may be performed to connect the outer extension front member and the outer extension rear member to the inner extension member and the outer upper member.

The outer extension front member, the outer extension rear member, the upper bulk head, the rear door hinge upper reinforcement member, and the outer upper member may be connected through a 5-layer joint.

For a rear vehicle body connection structure of the roof structure according to some embodiments, because parts of the basic vehicle body can be shared, the development period and investment cost of the vehicle body can be reduced.

For a rear vehicle body connection structure of the roof structure according to some embodiments, mass production can be secured by assembling the high roof module into the basic vehicle body through an inline process.

Advantages that can be obtained or expected from the disclosed example embodiments are disclosed directly or implicitly in the detailed description of the present disclosure. That is, various advantages expected according to the disclosed example embodiments will be disclosed in the detailed description that follows.

### BRIEF DESCRIPTION OF THE DRAWINGS

The drawings are intended for reference in describing example embodiments of the present disclosure, and therefore technical ideas of the disclosed example embodiments should not be construed as necessarily limited to the accompanying drawings.

FIG. 1 is a perspective view illustrating a rear vehicle body to which a rear vehicle body connection structure of a roof structure according to an example embodiment can be applied.

FIG. 2 is a rear view illustrating a rear vehicle body to which a rear vehicle body connection structure of a roof structure according to an example embodiment can be applied.

FIG. 3A and FIG. 3B are combined and exploded perspective views illustrating various rear vehicle body connection structures of roof structures according to some example embodiments.

FIG. 4 and FIG. 5 are exploded perspective views illustrating rear vehicle body connection structures of roof structures according to some example embodiments.

FIG. 6 is an exploded perspective view illustrating an inner joint part and an outer joint part applied to a rear vehicle body connection structure of a roof structure according to an example embodiment.

FIG. 7A and FIG. 7B are drawings illustrating high roof modules configured to be applied to a rear vehicle body connection structure of a roof structure according to some example embodiments.

FIG. 8 is a drawing showing a joint structure of a high roof module and an inner joint part applied to a rear vehicle body connection structure of a roof structure according to an example embodiment.

FIG. 9 is a drawing showing a joint structure of a high roof module and an inner joint part applied to a rear vehicle body connection structure of a roof structure according to an example embodiment.

FIG. 10A is a drawing illustrating an upper joint part applied to a rear vehicle body connection structure of a roof structure according to an example embodiment.

FIG. 10B is a drawing illustrating an upper joint part applied to a rear vehicle body connection structure of a roof structure according to an example embodiment.

FIG. 11 is a cross-sectional view along line A-A of FIG. 10B.

FIG. 12 to FIG. 15 are drawings for explaining assembly processes of rear vehicle body connection structures of roof structures according to some example embodiments.

The drawings referenced above are not necessarily drawn to scale, and may be understood as presenting rather simplified representations of various features that illustrate some principles of some example embodiments. For example, certain design features of the disclosed embodiments, including specific dimensions, direction, position, and shape, may be determined in part by the particular intended application and usage environment.

### DETAILED DESCRIPTION OF ILLUSTRATIVE EMBODIMENTS

Hereinafter, with reference to the attached drawings, example embodiments of the present disclosure will be described in detail so that a person having ordinary skill in the art to which the present disclosure pertains can easily practice embodiments of the present disclosure. As those skilled in the art may realize, the described example embodiments may be modified and combined in various different ways for other embodiments, without departing from the spirit or scopes of the present disclosure.

Terminology used herein is for the purpose of describing example embodiments and is not intended to necessarily limit the present disclosure. As used herein, singular forms may be intended to include plural forms as well, unless the context clearly indicates otherwise.

It should also be understood that the terms “comprise” and/or “include” as used herein indicate the presence of stated features, integers, steps, operations, elements and/or components, but do not preclude the presence or addition of one or more other features, integers, steps, operations, components, and/or groups thereof. As used herein, the term “and/or” includes any and all combinations of one or more of the associated listed items.

In this specification, the term “connected” indicates a physical relationship between two components where the components are directly connected to each other by welding, SPR (Self Piercing Rivet), FDS (Flow Drill Screw), structural adhesive, etc., or indirectly connected through one or more intermediate components.

As used herein, “vehicle”, “vehicular”, “automotive” or other similar terms as used herein may generally refer to passenger vehicles, sports cars, sport utility vehicles (SUVs), buses, trucks, tractors, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, some example embodiments of the present disclosure will be described in detail with reference to the attached drawings.

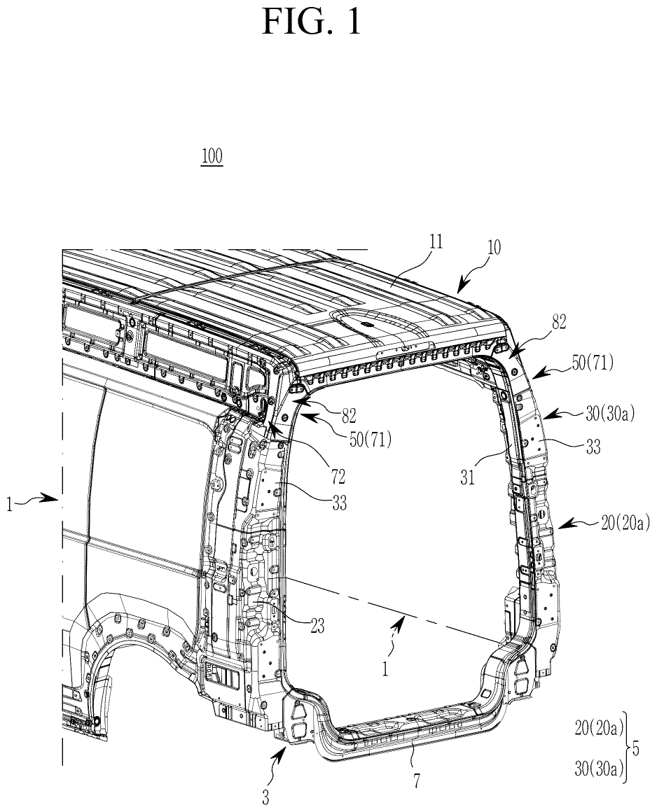

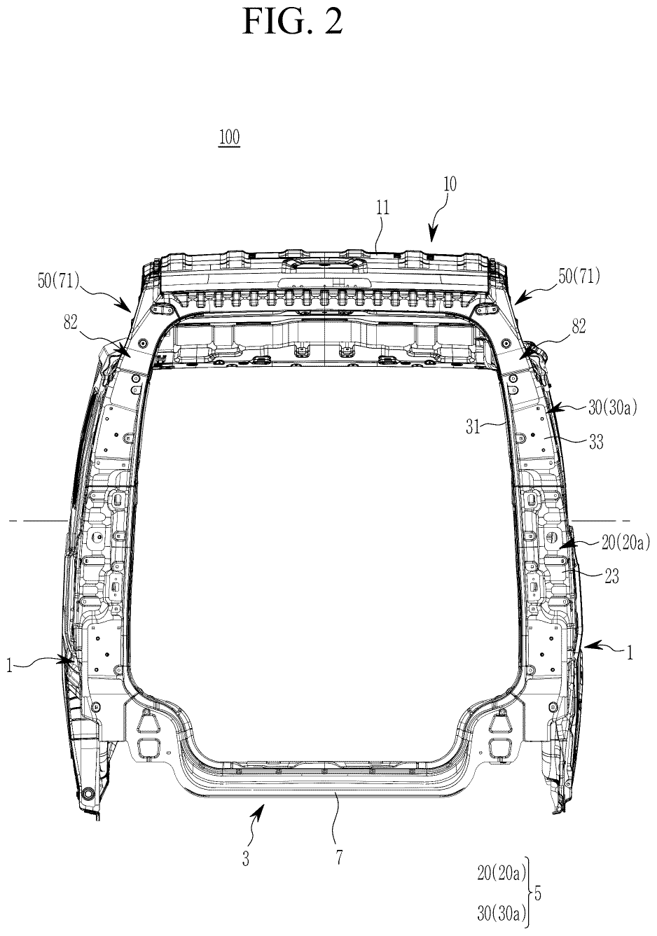

FIG. 1 is a perspective view illustrating a rear vehicle body to which a rear vehicle body connection structure of a roof structure according to an example embodiment is applied. FIG. 2 is a rear view illustrating a rear vehicle body to which a rear vehicle body connection structure of a roof structure according to an example embodiment is applied.

Referring to FIG. 1 and FIG. 2, the rear vehicle body connection structure 100 of the roof structure according to some embodiments may be applied, for example, to the vehicle body of a purpose-based mobility vehicle (Purpose Built Vehicle: hereinafter referred to as “PBV”).

In some embodiments, the PBV may be utilized as an electric vehicle-based life module vehicle that provides various customized services to users during the time they travel from the departure point to the destination.

In one example, the PBV may be manufactured as a one box type design with a wide vehicle interior space. The PBV may also apply facing-type seats to the vehicle interior space. The vehicle body of the PBV may be manufactured in various shapes and sizes depending on the purpose of use of the PBV.

The vehicle body of the PBV may be utilized as a variety of vehicle types, such as a hailing vehicle as a means of transporting occupants, a delivery vehicle for transporting goods, and a special vehicle such as an ambulance.

The vehicle body of the PBV may include a high roof module 10 to provide a wide vehicle interior space to the user.

The high roof module 10 may be mounted on top of a side structure 1 of the PBV vehicle body. The high roof module 10 may include a high roof panel 11 positioned at a predetermined height difference from a rear vehicle body 3.

In some embodiments, the side structure 1 may be designed to form a cabin or luggage room of a wide vehicle interior space inside the vehicle body. The side structure 1 may be equipped with a vehicle door, such as a sliding door or swing door. Depending on the vehicle type, the door may not be mounted on side structure 1. The side structure 1 may be equipped with a door window, for example, an openable door, or fixed glass, or may not have a window mounted, depending on the vehicle type, for example.

The rear vehicle body 3 may be the rear portion of the side structure 1. The rear vehicle body 3 may include a rear pillar 5 arranged along a vertical direction on both sides along the vehicle height direction, and a back panel 7 connecting the lower part of the rear pillar 5 along the vehicle width direction.

The rear vehicle body 3 may be mounted with at least one rear door (e.g., a tailgate) for opening and closing the cabin or luggage room. The at least one rear door may include, for example, twin swing doors (not shown) that are rotatably mounted on the rear pillar 5. The twin swing doors may be rotatably mounted via hinges on the rear pillar 5. The configuration and operation of a twin swing door that may be opened and closed through a hinge are matters that may be apparent to those skilled in the art, and thus a detailed description is omitted.

In this specification, the reference direction for describing the components below may be set as the vehicle body front-back direction (e.g., vehicle body length direction or longitudinal direction), vehicle width direction (e.g., lateral direction or left-right direction), and vertical direction (e.g., height direction or vehicle height direction) with the vehicle body as reference.

In this specification, the “top”, “upper”, or “upper face” of a component refers to an end, section, or face of the component that is relatively higher in the drawing, and the “bottom”, “lower”, or “lower face” of a component refers to an end, section, or face of the component that is relatively lower in the drawing.

In this specification, the term “end” of a component (e.g., one end, the other end, or both ends, etc.) refers to an end of the component in any one direction, and the term “end portion” of a component (e.g., one end portion, the other end portion, both end portions, the front end portion, or the rear end portion, etc.) refers to a portion of the component that includes that end.

The rear vehicle body connection structure 100 of the roof structure according to an example embodiment may be configured to connect the upper part of the rear pillar 5 and the rear portion of the high roof module 10.

The rear vehicle body 3 may have a door opening flange formed by the high roof module 10, the rear pillar 5, and the back panel 7. The door opening flange may be rotatably mounted with a twin swing door as described above.

The rear vehicle body connection structure 100 of the roof structure according to an example embodiment may secure a high vehicle body height and a wide vehicle interior space by the high roof module 10, and provide a structure suitable for inline mass production.

The rear vehicle body connection structure 100 of the roof structure according to an example embodiment may provide a structure that may commonize the basic vehicle body of various vehicle types to which the high roof module 10 may be applied.

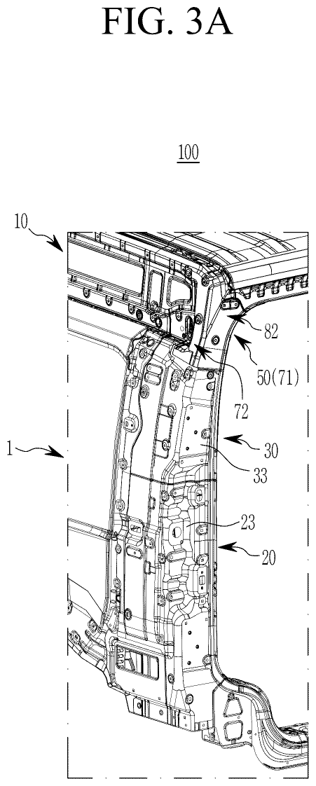

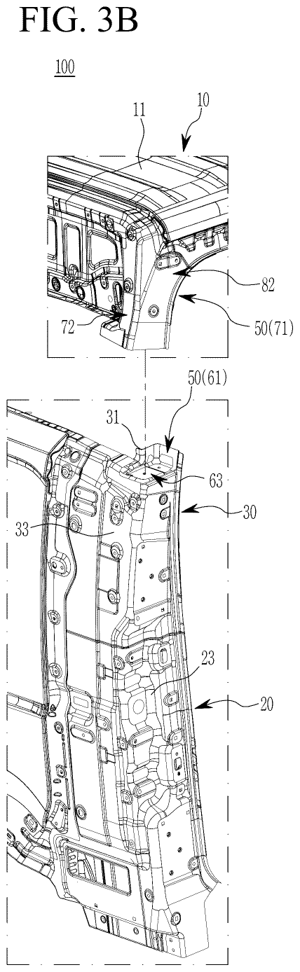

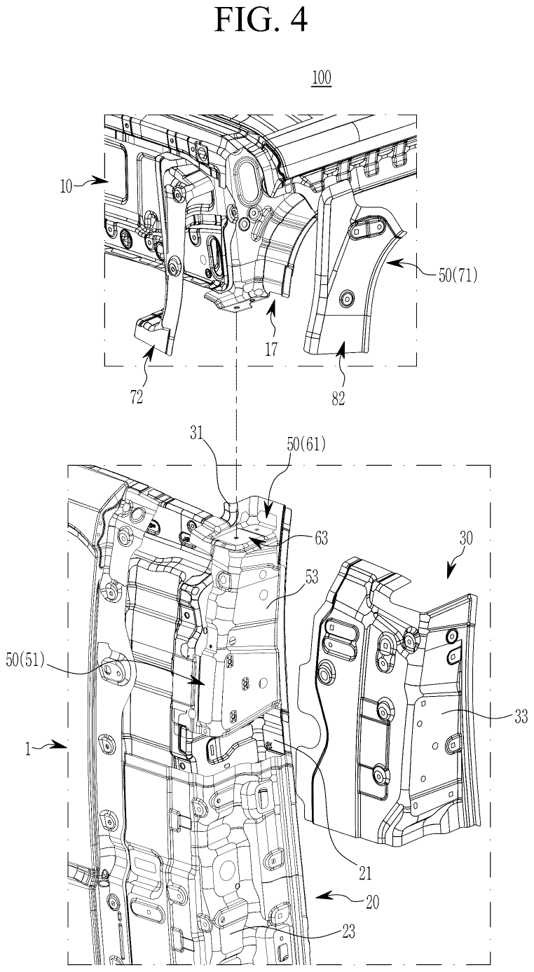

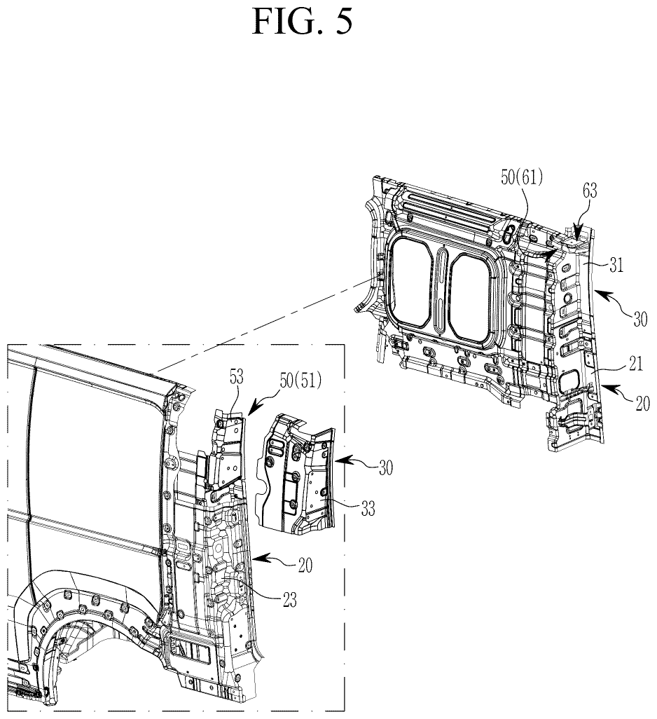

FIG. 3A and FIG. 3B are combined and exploded perspective views illustrating a rear vehicle body connection structure of a roof structure according to an example embodiment. FIG. 4 and FIG. 5 are exploded perspective views illustrating a rear vehicle body connection structure of a roof structure according to an example embodiment.

Referring to FIG. 3A to FIG. 5, the rear vehicle body connection structure 100 of the roof structure according to some example embodiments may include a rear pillar lower unit 20, a rear pillar upper unit 30, and a joint unit 50.

In an example embodiment, the rear pillar lower unit 20 may be provided as a lower part of the rear pillar 5 in the rear vehicle body 3. The rear pillar lower unit 20 may be equipped as a common element 20a of the rear vehicle body 3.

In some embodiments, the common element 20a may be a component of the basic vehicle body, and in some embodiments, may be referred to as a common component of the rear vehicle body 3 that is not replaced even if the purpose of use of the PBV changes. In some embodiments, the basic vehicle body may be referred to as a vehicle body that does not have a high overall height and does not have a high roof structure.

The rear pillar lower unit 20 may be connected along the vehicle height direction via the back panel 7 mentioned above. The rear pillar lower unit 20 may include an inner lower member 21 and an outer lower member 23.

The inner lower member 21 may be joined to the rear lower part of the side structure 1. The outer lower member 23 may be connected to the inner lower member 21.

In some embodiments, the inner lower member 21 and the outer lower member 23 are connected to each other and may form a closed cross-section.

In an example embodiment, the rear pillar upper unit 30 may be connected to the upper part of the rear pillar lower unit 20. In some embodiments, the rear pillar upper unit 30 and the rear pillar lower unit 20 are connected to each other and may be provided as the rear pillar 5 (see FIG. 2) of the rear vehicle body 3 (see FIG. 2). In some embodiments, the rear pillar upper unit 30 may be equipped as a variable element 30a of the rear vehicle body 3.

In some embodiments, the variable element 30a is a component connected to the rear pillar lower unit 20 of the basic vehicle body, and may be referred to as a variable component of the rear vehicle body 3 that may be replaced depending on the purpose of use of the PBV and various vehicle types in the some embodiments. The various vehicle types may refer to various configurations of variable element 30a, and may include, for example, a hailing vehicle, a delivery vehicle, and a special vehicle.

In some embodiments, the length and parts of the rear pillar upper unit 30 along the vertical direction may be varied depending on the predetermined height of the vehicle body and the structure of the high roof module 10.

The rear pillar upper unit 30 may include an inner upper member 31 and an outer upper member 33.

The inner upper member 31 may be connected to the inner lower member 21 of the rear pillar lower unit 20.

The outer upper member 33 may be connected to the outer lower member 23 of the rear pillar lower unit 20.

In some embodiments, the inner upper member 31 and the outer upper member 33 may be connected to each other and form a closed cross-section.

In an example embodiment, the joint unit 50 is configured to connect the rear pillar upper unit 30 and the rear portion of the high roof module 10. In some embodiments, the joint unit 50 may be configured to reinforce the connection strength between the upper part of the rear pillar upper unit 30 and the rear part of the high roof module 10.

The joint unit 50 may include an outer joint part 51, an inner joint part 61, and at least one upper joint part 71.

The outer joint part 51 may include a rear door hinge upper reinforcement member 53. The inner joint part 61 may include an upper bulk head 63. The at least one upper joint part 71 may include an outer extension front member 72 and an outer extension rear member 82.

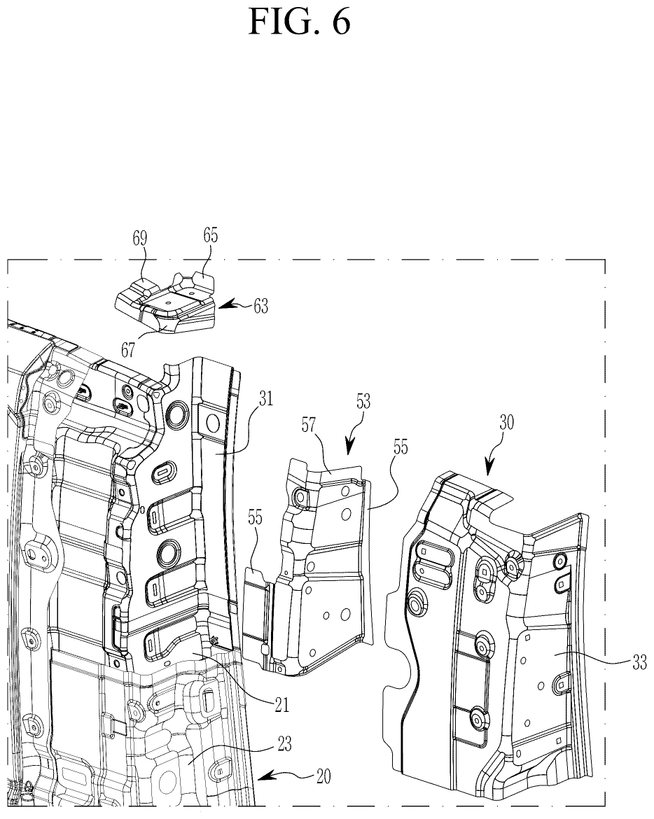

FIG. 6 is an exploded perspective view illustrating an inner joint part and an outer joint part applied to a rear vehicle body connection structure of a roof structure according to an example embodiment.

Referring to FIG. 3A to FIG. 6, in some embodiments, the rear door hinge upper reinforcement member 53 mounts the hinge of the twin swing door to the upper part of the rear pillar upper unit 30 and may be configured to reinforce the mounting strength of the hinge to the upper part of the rear pillar upper unit 30.

The rear door hinge upper reinforcement member 53 may be placed between the connected inner upper member 31 and the outer upper member 33 of the rear pillar upper unit 30. The rear door hinge upper reinforcement member 53 may be connected to the inner surface of the outer upper member 33 and may be connected to the inner upper member 31.

In an example embodiment, the upper bulk head 63 may connect the upper part of the rear pillar upper unit 30 and the rear portion of the high roof module 10, and may be configured to reinforce the connection strength between the rear pillar upper unit 30 and the high roof module 10.

The upper bulk head 63 may be placed between the connected inner upper member 31 and the rear door hinge upper reinforcement member 53. The upper bulk head 63 may be connected to the inner surface of the inner upper member 31 and the upper part of the rear door hinge upper reinforcement member 53, and may be connected to the upper part of the outer upper member 33.

In some embodiments, the upper bulk head 63 may include a first flange portion 65 and a second flange portion 67 formed at the edge portion.

In some embodiments, the first flange portion 65 is formed on a part of the edge of the upper bulk head 63 and may be connected to the inner surface of the inner upper member 31. The second flange portion 67 may be formed on the remaining edge of the upper bulk head 63 and may be connected to the upper surface of the outer upper member 33 and the upper part of the rear door hinge upper reinforcement member 53.

The rear door hinge upper reinforcement member 53 may include a side flange portion 55 and an upper flange portion 57 formed at the edge portion.

In some embodiments, the side flange portion 55 is formed on both sides of the rear door hinge upper reinforcement member 53 along the vehicle width direction, and may be connected to the edge portions on both sides of the inner upper member 31. In some embodiments, the upper flange portion 57 is formed on the upper part of the rear door hinge upper reinforcement member 53 and may be connected to the second flange portion 67 of the upper bulk head 63.

The upper flange portion 57 may be connected to the upper part of the outer upper member 33. In some embodiments, the second flange portion 67 of the upper bulk head 63, the upper flange portion 57 of the rear door hinge upper reinforcement member 53, and the upper part of the outer upper member 33 may be interconnected by a three-layer joint.

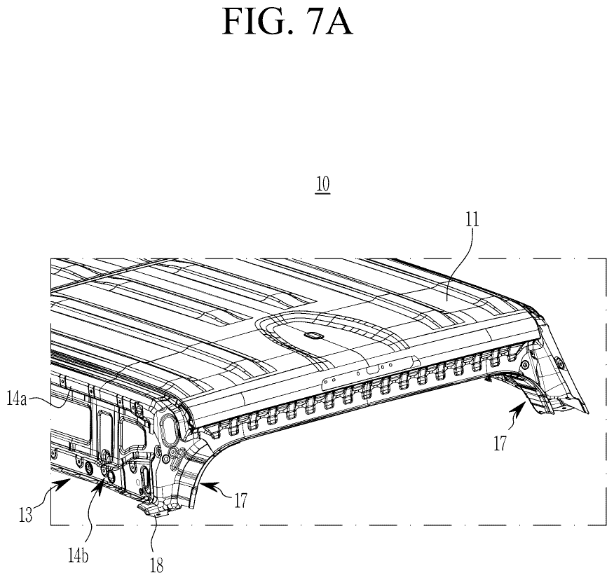

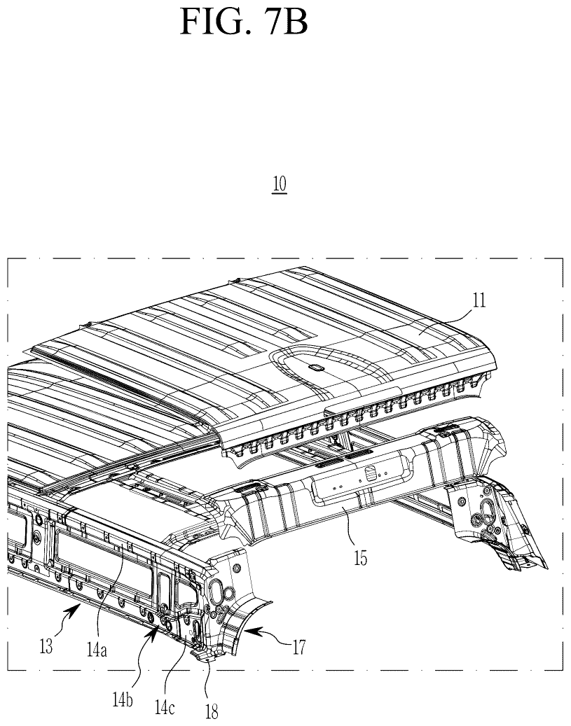

FIG. 7A and FIG. 7B are drawings illustrating a high roof module applied to a rear vehicle body connection structure of a roof structure according to some example embodiments.

The high roof module 10 applied to the rear vehicle body connection structure 100 of a roof structure according to an example embodiment may include, as shown in FIG. 7A and as shown in FIG. 7B, module side portions 13 on both sides, a rear roof rail 15, and an inner extension member 17.

The module side portions 13 on both sides may be provided on both sides along the vehicle width direction. The module side portions 13 may be connected to the upper part of the side structure 1 (see FIG. 1) of the PBV vehicle body. The module side portion 13 may include an upper side sill 14a and a lower side sill 14b arranged along the front-rear direction of the vehicle body. In some embodiments, the upper side sill 14a may be connected to the high roof panel 11 at a predetermined height difference with the rear vehicle body 3 (see FIG. 1).

The rear roof rail 15 may be connected to the rear of the module side portion 13 along the vehicle width direction. The rear roof rail 15 may be connected to the upper side sill 14a of the module side portion 13 along the vehicle width direction. The rear roof rail 15 may be connected to the bottom surface of the high roof panel 11.

The inner extension member 17 may be connected the module side portion 13 and the rear roof rail 15. The inner extension member 17 may be connected to the rear end of the module side portion 13 and may be connected to the end of the rear roof rail 15. The inner extension member 17 may include a support bracket 18 connected to the upper part of the rear vehicle body 3 (see FIG. 1).

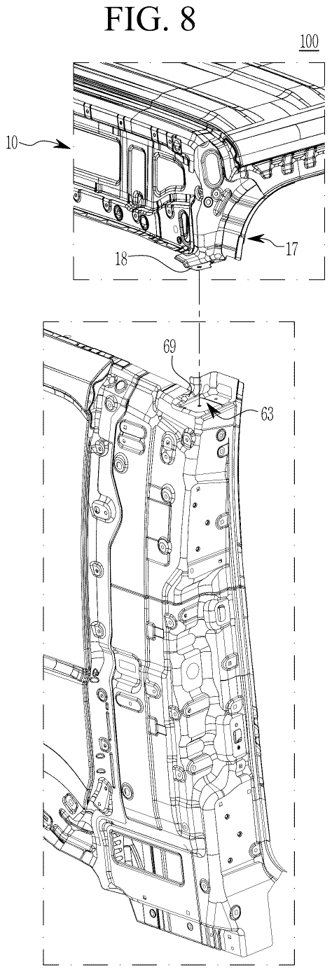

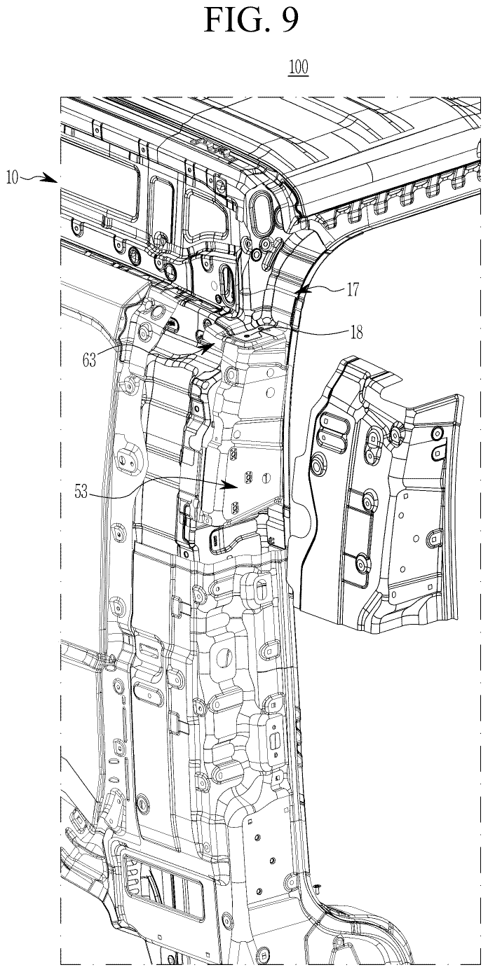

FIG. 8 and FIG. 9 are drawings showing a joint structure of a high roof module and an inner joint part applied to a rear vehicle body connection structure of a roof structure according to some example embodiments.

As shown in FIG. 8 and FIG. 9, the high roof module 10 may be connected along the vertical direction with the upper bulk head 63.

The inner extension member 17 of the high roof module 10 may be connected to the upper bulk head 63 via the support bracket 18. The support bracket 18 may be connected to the inside edge of the upper bulk head 63. The upper bulk head 63 may include a forming part 69 connected to the support bracket 18, as shown in FIG. 6 and FIG. 8. The forming part 69 may be formed to protrude upward from the inner edge of the upper bulk head 63.

The support bracket 18, the upper bulk head 63, and the rear door hinge upper reinforcement member 53 may be connected along the vertical direction.

Referring to FIG. 3 and FIG. 4, in some embodiments, the at least one upper joint part 71 may be connected to the inner extension member 17 of the high roof module 10 and may be connected along the vertical direction to the upper bulk head 63 and the rear door hinge upper reinforcement member 53 via the outer upper member 33.

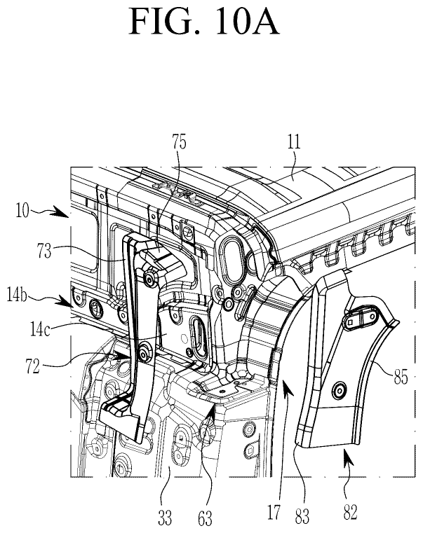

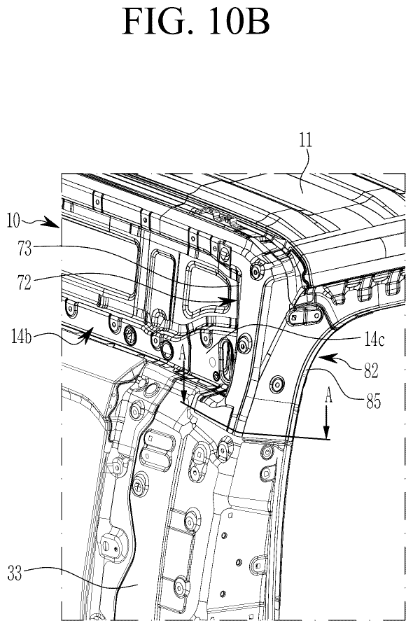

FIG. 10A and FIG. 10B are drawings illustrating an upper joint part applied to a rear vehicle body connection structure of a roof structure according to some example embodiments.

Referring to FIG. 3A, FIG. 3B, FIG. 4, FIG. 10A and FIG. 10B, in some embodiments, the outer extension front member 72 of the upper joint part 71 may be connected to the front portion of the inner extension member 17 via a front flange portion 73.

The lower part of the outer extension front member 72 may be connected to the upper part of the outer upper member 33. The upper part of the outer extension front member 72 may be connected to the high roof panel 11 via a third flange portion 75.

The outer extension front member 72 may be connected to the lower side sill 14b of the high roof module 10 along the front-rear direction of the vehicle body via the front flange portion 73. The front flange portion 73 may be connected to the side sill rear portion 14c provided at the rear of the lower side sill 14b along the front-rear direction of the vehicle body.

The outer extension front member 72 may be connected to the inner extension member 17, the upper bulk head 63, and the rear door hinge upper reinforcement member 53 via the outer upper member 33.

The outer extension rear member 82 of the upper joint part 71 may be connected to the outer extension front member 72 via a fourth flange portion 83.

The outer extension rear member 82 may be connected to the rear portion of the inner extension member 17 via a fifth flange portion 85. The lower part of the outer extension rear member 82 may be connected to the upper part of the outer upper member 33. The upper part of the outer extension rear member 82 may be connected to the high roof panel 11.

The outer extension rear member 82 may be connected to the inner extension member 17, the upper bulk head 63, and the rear door hinge upper reinforcement member 53 via the outer upper member 33.

The outer extension front member 72, the outer extension rear member 82, the upper bulk head 63, and the rear door hinge upper reinforcement member 53 may be connected along the vertical direction through the outer upper member 33.

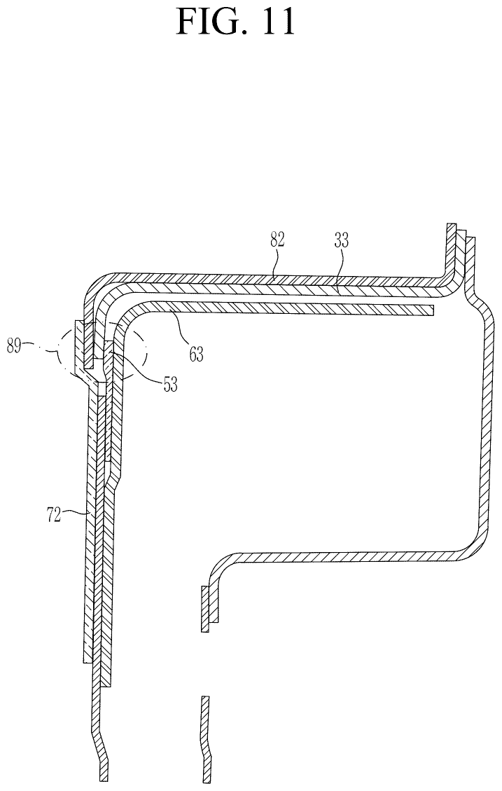

FIG. 11 is a cross-sectional view along line A-A of FIG. 10B.

As shown in FIG. 11, in some embodiments, the outer extension front member 72, the outer extension rear member 82, the upper bulk head 63, the rear door hinge upper reinforcement member 53, and the outer upper member 33 may be interconnected via a 5-layer joint 89.

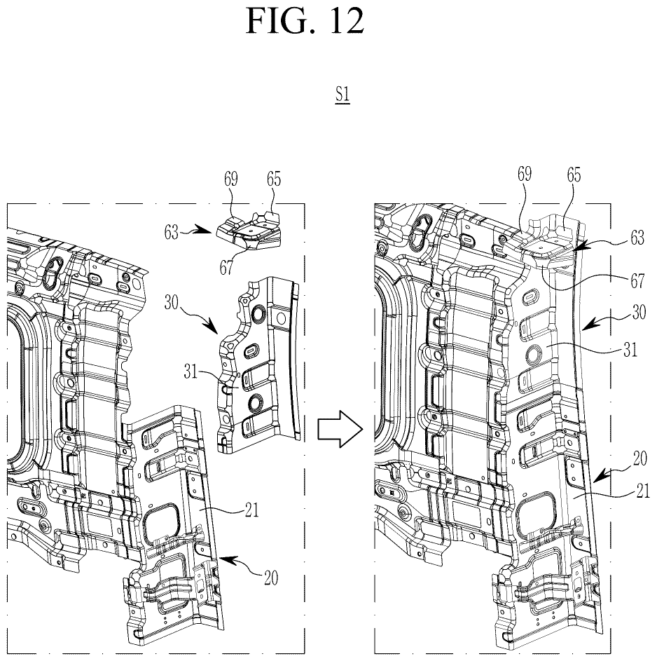

Hereinafter, an assembly process and operation of a rear vehicle body connection structure 100 of a roof structure according to some example embodiments configured as described above will be described in detail referring to FIG. 12 to FIG. 15.

FIG. 12 to FIG. 15 are drawings for explaining assembly processes of a rear vehicle body connection structure of the roof structure according to some example embodiments.

In an example embodiment, as shown in FIG. 2, the basic vehicle body is provided having the rear pillar lower unit 20 as the common element 20a.

Referring to FIG. 12, in an example embodiment, a first assembly process S1 may be performed to join the upper bulk head 63 to the inner upper member 31 of the rear pillar upper unit 30 as the variable element 30a. The upper bulk head 63 may be connected to the inner surface of the inner upper member 31 via the first flange portion 65.

In the first assembly process S1, the inner upper member 31 connected to the upper bulk head 63 may be connected to the inner lower member 21 of the rear pillar lower unit 20.

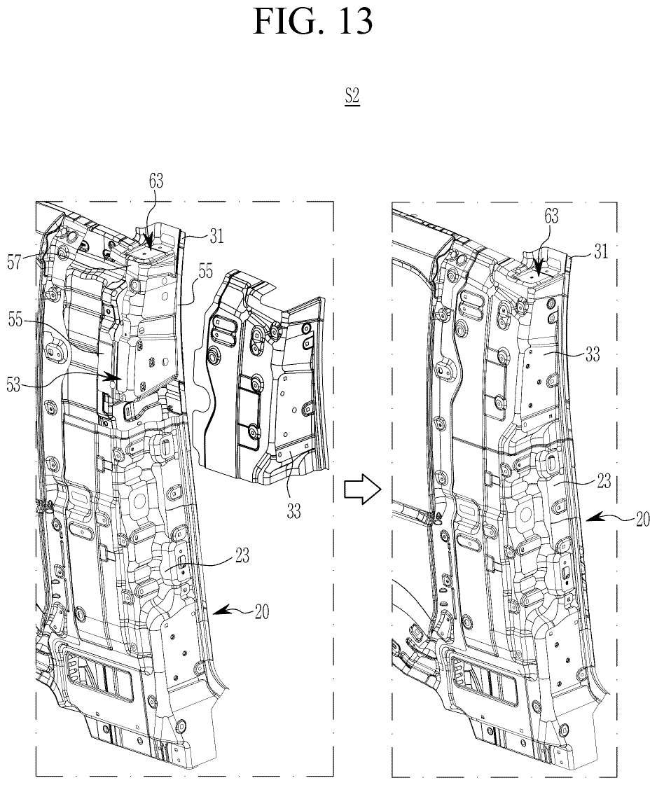

Referring to FIG. 13, in an example embodiment, a secondary assembly process S2 may be performed to join the rear door hinge upper reinforcement member 53 to the inner upper member 31 and the upper bulk head 63.

The rear door hinge upper reinforcement member 53 may be connected to both edge portions of the inner upper member 31 through the side flange portion 55. The rear door hinge upper reinforcement member 53 may be connected to the second flange portion 67 (see FIG. 12) of the upper bulk head 63 via the upper flange portion 57.

In the secondary assembly process S2, the outer upper member 33 may be connected to the rear door hinge upper reinforcement member 53.

The rear door hinge upper reinforcement member 53 may be connected to the inner surface of the outer upper member 33. The upper part of the outer upper member 33 may be connected to the upper flange portion 57 of the rear door hinge upper reinforcement member 53 and the second flange portion 67 (see FIG. 12) of the upper bulk head 63. The lower part of the outer upper member 33 may be connected to the outer lower member 23 of the rear pillar lower unit 20.

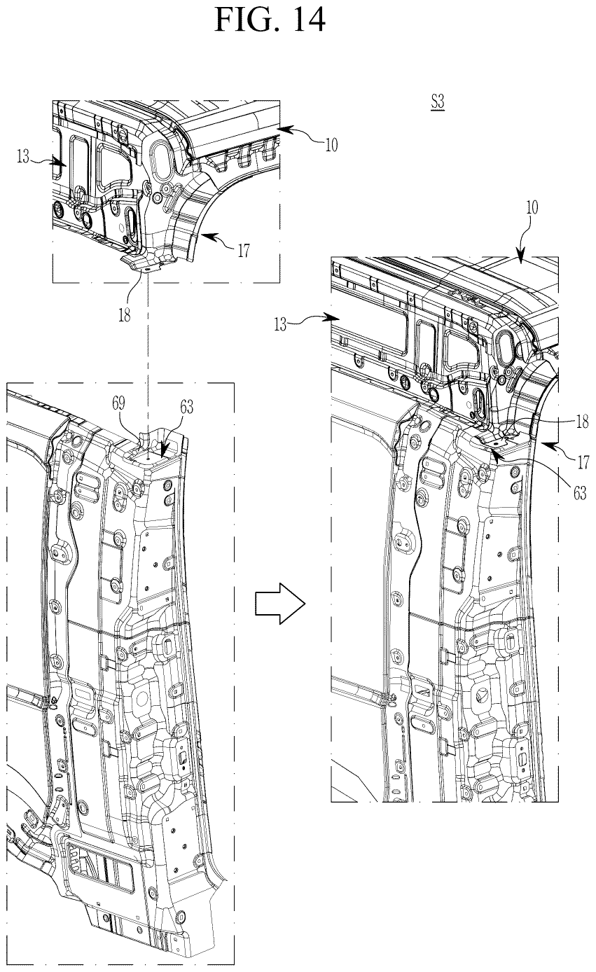

Referring to FIG. 14, in an example embodiment, the high roof module 10 may be provided including the module side portion 13, the rear roof rail 15 (see FIG. 7), and the inner extension member 17.

A third assembly process S3 may be performed to combine the inner extension member 17 of the high roof module 10 and the upper bulk head 63.

In the third assembly process S3, the inner extension member 17 may be loaded onto the upper surface of the upper bulk head 63 via the support bracket 18. The support bracket 18 may be connected to the upper surface of the upper bulk head 63 via the forming part 69 of the upper bulk head 63.

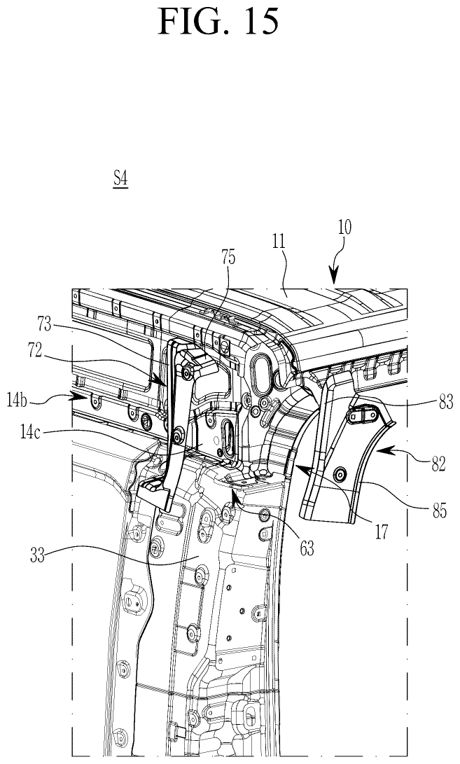

Referring to FIG. 15, in an example embodiment, a fourth assembly process S4 may be performed to join the outer extension front member 72 and the outer extension rear member 82 to the inner extension member 17 and the outer upper member 33.

In the fourth assembly process S4, the front flange portion 73 of the outer extension front member 72 may be connected to the front part of the inner extension member 17. The lower part of the outer extension front member 72 may be connected to the upper part of the outer upper member 33. The upper part of the outer extension front member 72 may be connected to the high roof panel 11 via the third flange portion 75.

The front flange portion 73 may be connected to the side sill rear portion 14c provided at the rear of the lower side sill 14b of the high roof module 10.

In some embodiments, the outer extension front member 72 may be connected to the inner extension member 17 and the outer upper member 33, and connected to the upper bulk head 63 and the rear door hinge upper reinforcement member 53 via the outer upper member 33.

In the fourth assembly process S4, the fourth flange portion 83 of the outer extension rear member 82 may be connected to the rear portion of the outer extension front member 72. The fifth flange portion 85 of the outer extension rear member 82 may be connected to the rear portion of the inner extension member 17.

In some embodiments, the lower part of the outer extension rear member 82 may be connected to the upper part of the outer upper member 33, and the upper part of the outer extension rear member 82 may be connected to the high roof panel 11.

In some embodiments, the outer extension rear member 82 may be connected to the inner extension member 17, the outer upper member 33, and the outer extension front member 72, and connected to the upper bulk head 63 and the rear door hinge upper reinforcement member 53 via the outer upper member 33.

The upper bulk head 63, the rear door hinge upper reinforcement member 53, and the inner extension member 17 may be connected along the vertical direction. The outer extension front member 72 and the outer extension rear member 82 may be connected along the vertical direction to the upper bulk head 63 and the rear door hinge upper reinforcement member 53 via the inner extension member 17 and the outer upper member 33.

For a rear vehicle body connection structure 100 of a roof structure according to some embodiments, the high roof module 10 may be connected to the upper part of the rear vehicle body 3.

A rear vehicle body connection structure 100 of a roof structure according to some embodiments may secure a height of the vehicle body increased by the high roof module 10 and provide a wide vehicle interior space to the user.

For a rear vehicle body connection structure 100 of a roof structure according to some embodiments, the rear pillar lower unit 20 of the basic vehicle body may be provided as the common element 20a, the rear pillar upper unit 30, which is the variable element 30a, may be assembled to the rear pillar lower unit 20, and the rear pillar upper unit 30 and the high roof module 10 may be connected via the joint unit 50.

For a rear vehicle body connection structure 100 of a roof structure according to some embodiments, because parts of the basic vehicle body may be shared, the development period and investment cost of the vehicle body may be reduced.

For a rear vehicle body connection structure 100 of a roof structure according to some embodiments, mass production can be secured by assembling the high roof module 10 into the basic vehicle body through an inline process.

For a rear vehicle body connection structure 100 of a roof structure according to some embodiments, mass production may be ensured by assembling the high roof module 10 inline with the basic vehicle body.

For a rear vehicle body connection structure 100 of a roof structure according to some embodiments, the mounting strength and connection strength of the rear vehicle body 3 and the high roof module 10 may be further strengthened.

While the present disclosure has been described in connection with what is presently considered to be some practical example embodiments, it may be understood that the present disclosure is not necessarily limited to the disclosed example embodiments. On the contrary, the present disclosure is intended to cover various modifications and equivalent arrangements included within the spirit and scopes of the appended claims and equivalents thereof.

What is claimed is:

1. A rear vehicle body connection structure of a roof structure that connects a high-roof module including a high-roof panel arranged at a height difference from a rear vehicle body to the rear vehicle body, wherein the rear vehicle body includes a rear pillar lower unit as a common element, the rear vehicle body connection structure comprising:
a rear pillar upper unit connected to the rear pillar lower unit; and
a joint unit connecting an upper part of the rear pillar upper unit and a rear part of the high-roof module.

2. The rear vehicle body connection structure of claim 1, wherein the rear pillar upper unit is equipped as a variable element of the rear vehicle body.

3. The rear vehicle body connection structure of claim 1, wherein the rear pillar upper unit comprises:
an inner upper member connected to an inner lower member of the rear pillar lower unit; and
an outer upper member connected to an outer lower member of the rear pillar lower unit and the inner upper member.

4. The rear vehicle body connection structure of claim 3, wherein the joint unit comprises:
a rear door hinge upper reinforcement member connected to the inner upper member and the outer upper member; and
an upper bulk head connected to the inner upper member and the outer upper member, and connected to an upper part of the rear door hinge upper reinforcement member.

5. The rear vehicle body connection structure of claim 4, wherein the upper bulk head is provided as an inner joint part, and the rear door hinge upper reinforcement member is provided as an outer joint part.

6. The rear vehicle body connection structure of claim 4, wherein the upper bulk head comprises:
a first flange portion connected to the inner upper member; and
a second flange portion connected to the outer upper member and the rear door hinge upper reinforcement member.

7. The rear vehicle body connection structure of claim 6, wherein the rear door hinge upper reinforcement member comprises:
a side flange portion connected to the inner upper member; and
an upper flange portion connected to the upper bulk head.

8. The rear vehicle body connection structure of claim 4, further comprising an inner extension member connected to module side portions on both sides and both ends of a rear roof rail at a rear of the high-roof module, wherein the inner extension member is connected to the upper bulk head.

9. The rear vehicle body connection structure of claim 8, further comprising a support bracket on the inner extension member, and wherein the upper bulk head comprises a forming part connected to the support bracket.

10. The rear vehicle body connection structure of claim 8, further comprising support brackets connected on the inner extension member, the upper bulk head, and the rear door hinge upper reinforcement member along a vertical direction.

11. The rear vehicle body connection structure of claim 4, further comprising inner extension members connected to module side portions on both sides and ends of a rear roof rail at a rear portion of the high-roof module, wherein the joint unit further comprises upper joint parts connected to the inner extension members.

12. The rear vehicle body connection structure of claim 11, wherein each of the upper joint parts comprises:
an outer extension front member connected to a respective one of the inner extension members, the upper bulk head, and the rear door hinge upper reinforcement member; and
an outer extension rear member connected to the outer extension front member and connected to a respective one of the inner extension members, the upper bulk head, and the rear door hinge upper reinforcement member.

13. The rear vehicle body connection structure of claim 12, wherein the outer extension front member, the outer extension rear member, the upper bulk head, and the rear door hinge upper reinforcement member are connected along a vertical direction through the outer upper member.

14. The rear vehicle body connection structure of claim 12, wherein the outer extension front member, the outer extension rear member, the upper bulk head, the rear door hinge upper reinforcement member, and the outer upper member are connected through a 5-layer joint.

15. A modular vehicle comprising:
a common rear vehicle body including a rear pillar lower unit as a common element;
a modular roof structure comprising a high-roof module, wherein the high-roof module includes a high-roof panel arranged at a height difference from the common rear vehicle body; and
a modular rear vehicle body connection structure configured to fit with the common rear vehicle body, wherein the modular rear vehicle body connection structure comprises:
a rear pillar upper unit connected to the rear pillar lower unit; and
a joint unit connecting an upper part of the rear pillar upper unit and a rear part of the high-roof module.

16. The modular vehicle of claim 15, wherein:
the rear pillar lower unit comprises:
an inner lower member, and
an outer lower member;
the rear pillar upper unit comprises:
an inner upper member connected to the inner lower member of the rear pillar lower unit, and
an outer upper member connected to the outer lower member of the rear pillar lower unit and the inner upper member;
wherein the joint unit comprises:
a rear door hinge upper reinforcement member connected to the inner upper member and the outer upper member, and
an upper bulk head connected to the inner upper member and the outer upper member, and connected to an upper part of the rear door hinge upper reinforcement member.

17. The modular vehicle of claim 16, wherein the modular rear vehicle body connection structure comprises inner extension members connected to module side portions on both sides and ends of a rear roof rail at a rear portion of the high-roof module;
wherein the joint unit further comprises upper joint parts connected to the inner extension members, wherein each of the upper joint parts comprises:
an outer extension front member connected to a respective one of the inner extension members, the upper bulk head, and the rear door hinge upper reinforcement member; and
an outer extension rear member connected to the outer extension front member and connected to a respective one of the inner extension members, the upper bulk head, and the rear door hinge upper reinforcement member;
wherein the outer extension front member, the outer extension rear member, the upper bulk head, and the rear door hinge upper reinforcement member are connected along a vertical direction through the outer upper member; and
wherein the outer extension front member, the outer extension rear member, the upper bulk head, the rear door hinge upper reinforcement member, and the outer upper member are connected through a 5-layer joint.

18. The modular vehicle of claim 17, wherein:
the upper bulk head is provided as an inner joint part;
the rear door hinge upper reinforcement member is provided as an outer joint part;
the upper bulk head comprises:
a first flange portion connected to the inner upper member, and
a second flange portion connected to the outer upper member and the rear door hinge upper reinforcement member;
the rear door hinge upper reinforcement member comprises:
a side flange portion connected to the inner upper member, and
an upper flange portion connected to the upper bulk head
the modular rear vehicle body connection structure further comprises:
an inner extension member connected to module side portions on both sides and both ends of a rear roof rail at a rear of the high-roof module, wherein the inner extension member is connected to the upper bulk head, and
a support bracket on the inner extension member, and wherein the upper bulk head comprises a forming part connected to the support bracket.

19. A method of assembling a rear vehicle body connection structure, the method comprising:
a first assembly process is performed by connecting an upper bulk head to an inner upper member and connecting the inner upper member to an inner lower member;
a secondary assembly process is performed by connecting a rear door hinge upper reinforcement member to the inner upper member and the upper bulk head, and connecting the rear door hinge upper reinforcement member to an outer lower member and an outer upper member; and
a third assembly process is performed by connecting an inner extension member with the upper bulk head.

20. The method of claim 19, further comprising:
after the third assembly process, a fourth assembly process is performed by connecting an outer extension front member and an outer extension rear member to the inner extension member and the outer upper member.
